(19) United States
(12) Patent Application Publication
(10) Pub. No.: US 2005/0010654 A1
(43) Pub. Date: Jan. 13, 2005

(54) peripheral community apparatus for computers output/input

(76) Inventor: Tseng I Lin, Taipei City (TW)

Correspondence Address: BIRCH STEWART KOLASCH & BIRCH, PO BOX 747, FALLS CHURCH, VA, 22040-0747, US

(21) Appl. No.: 10/614,974

(22) Filed: Jul. 9, 2003

(51) Int. Cl. G06F 15/177

(52) U.S. Cl. 709/220

(57) ABSTRACT

The present invention relates generally to a peripheral community apparatus for computers output/input, and more particularly, relates to an apparatus with a firmware that can be upgraded by the current PS2 protocol, wherein the PS2 ports of the peripheral community apparatus for computers output/input are coupled with the PS2 ports of keyboard/mouse on the computer, and the upgraded firmware programs are at first stored in the computer then transmitted into the Flash ROM of the peripheral community apparatus for computers output/input through the existing PS2 ports on both the peripheral community apparatus side and the computer side so that no change of the current connection arrangement is needed.

### BACKGROUND OF THE INVENTION

1. Field of the Invention

The present invention relates generally to a community of peripheral apparatus for computers output/input, and more particularly, it is utilized to integrate a plurality of computers to share the community of keyboard, mouse and monitor, the firmware of the present invention can be upgraded using the existing PS2 ports and current PS2 protocols.

2. Description of the Prior Art

A peripheral community apparatus for computers output/input, such as Central Processing Unit (CPU) and KVM SWITCH, is utilized to integrate a plurality of computers to share the community keyboard, mouse, monitor and so on. In view of the fact that keyboards, mousse and monitors are fast renewing, and that protocols are frequently modifying, the peripheral community apparatus for computers output/input is fast eliminated through competition and its firmware must catch up with new computers. At present, peripheral community apparatuses for computer output/input with the upgrading function(Flash Rom Type) need extra output/input ports, such as RJ-45 -DB-9 -DB-25 port, and signal lines to connect to computers, then by the RS-232/I²C protocol the upgrading firmware programs are burned into the Flash ROM of the current peripheral community apparatus for computers output/input. Illustrated in FIG. 1 is a framework diagram how the current peripheral community apparatus for two computers output/input is combined with the computers when upgrading the firmware. The framework comprises a current peripheral community apparatus 10 for two computers output/input, a first computer 20, a second computer 30, a community line connector 41, a first community line connector 42, a second community line connector 43, and a third community line connector 44, wherein the community line connector 41, the first community line connector 42 and the second community line connector 43 are formed by a keyboard signal line, a mouse signal line and a monitor signal line; the third community line connector 44 can be a line connector for a Serial port, a printer Parallel port, a LAN port or a USB port.

Furthermore, the current peripheral community apparatus for two computers output/input 10 comprises a community port 11, a first community port 12, a second community port 13, and a third community port 14; wherein the community port 11 is combined with a monitor 50, a keyboard 60, a mouse 70 by the community line connector 41; the first community port 12 is combined with the keyboard/mouse/monitor port 22 of the first computer 20 by the first community line connector 42; the second community port 13 is combined with the keyboard/mouse/monitor port 31 of the second computer 30 by the second community line connector 43. When the firmware of the current peripheral community apparatus 10 for two computers output/input is upgraded, at first the third community port 14 of the peripheral apparatus 10 for two computers output/input is combined with the first computer 20 or the second computer 30 by the third community line connector 44; in the case with the first computer 20; users store the upgrading firmware programs inside the first computer 20, then operate the keyboard 60 and the mouse 70 following the instructions on the monitor 50 to transmit the upgrading firmware programs, through the community line connector 44, from Serial port of the first computer 20 to the community port 11 and into the Flash Rom of the current peripheral community apparatus 10 for two computers output/input to complete the burning work. Whereby, the current peripheral community apparatus 10 for two computers output/input can keep working right with the new computers and the new peripheral apparatus.

### SUMMARY OF THE INVENTION

The present invention provides a peripheral community apparatus for computers output/input which needs not extra connection ports and signal lines, but the existing PS2 ports on the current computers in firmware upgrading process.

As described above, the present invention makes use of the existing PS2 ports on both the peripheral apparatus for computer output/input and computers for keyboard/mouse use to upgrade the firmware of the peripheral apparatus for computer output/input. The upgrading firmware program is at first stored in computer, then transmitted into the Flash Rom of the peripheral apparatus for computer output/input through the PS2 line connector to complete the burning work. Using the existing PS2 ports spares extra connection arrangement and complicated operation steps in upgrading process.

### BRIEF DESCRIPTION OF THE DRAWINGS

The foregoing aspects and many of the attendant advantages of the present invention will become more readily appreciated as the same becomes better understood by reference to the following detailed description, when taken in conjunction with the accompanying drawings, wherein:

FIG. 1 shows a framework illustrating how the current peripheral community apparatus for two computers output/input is combined with computers; and

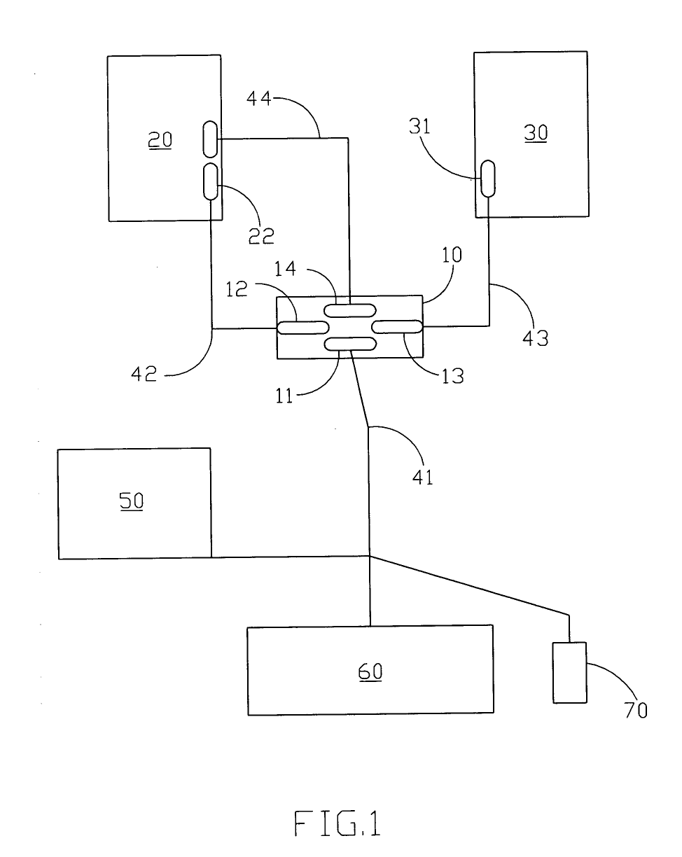

FIG.2 shows a framework illustrating how the peripheral community apparatus for two computers output/input is combined with the computers in accordance with one of the preferred embodiment.

### DESCRIPTION OF THE PREFERRED EMBODIMENT

What is probed into in the invention is a method needing no extra the connect ports and signal lines, but the existing PS2 ports when upgrading the firmware programs. Detailed steps in production, structure and elements will be provided in the following description in order to make the invention thoroughly understood. Obviously, the application of the invention is not confined to specific details familiar to those who are skilled in electromagnetic inductive system. On the other hand, the common elements and procedures that are known to everyone are not described in the details to avoid unnecessary limits of the invention. Some preferred embodiments of the present invention are described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

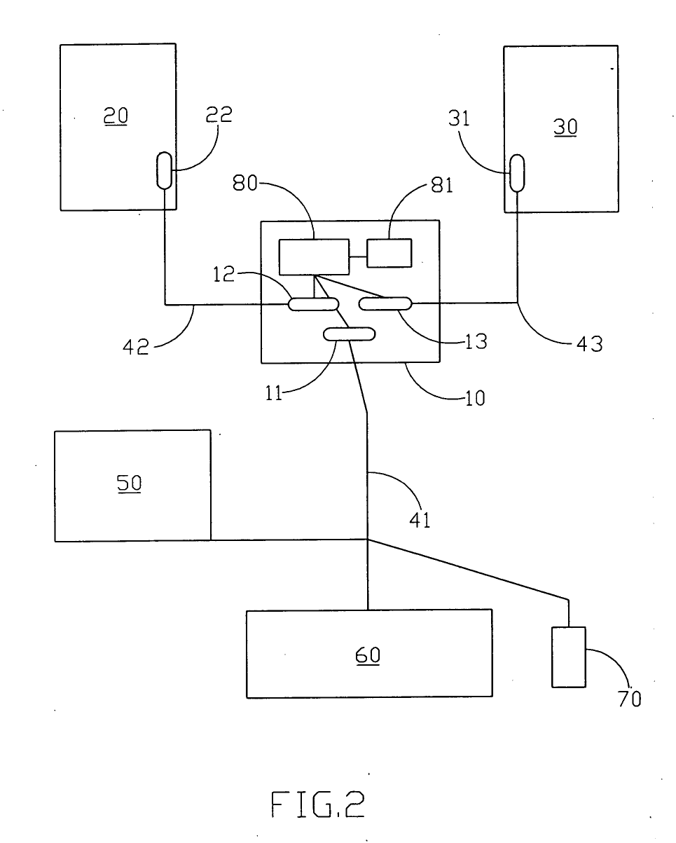

As illustrated in FIG. 2, in one preferred embodiment of the present invention, this invention provides a peripheral community apparatus 10′ for two computers output/input, the peripheral community apparatus 10′ comprises a community port 11, a first community port 12, a second community port 13, a control device 80 and a memory 81, such as a Flash ROM; wherein the memory 81 can be set inside the control device 80 or coupled with the control device 80; the community port 11 is combined with a monitor 50, a keyboard 60, a mouse 70 by the community line connector 41; the first community port 12 is combined with the keyboard/mouse/monitor ports 22 of the first computer 20 by the first community line connector 42; the second community port 13 is combined with the keyboard/mouse/monitor ports 31 of the second computer 30 by the second community line connector 43; when the firmware of the peripheral community apparatus 10′ for two computers output/input is upgraded, at first users store the upgrading firmware programs inside the computer 20/30, in the case 20, then operate the keyboard 60 and the mouse 70 are to upgrade the firmware programs. First a refreshing directive is transmitted from the PS2 port of the computer 20 used for keyboard to the control device 80 of the peripheral community apparatus 10′ for two computers output/input through the first community line connector 42, then when the control device 80 receives the refreshing directive, it transmits the confirmation signals back to the computer 20. If the control device 80 doesn't receive the start-refreshing directive in a certain period of time or the format of the refreshing directive is wrong, the control device 80 transmits an informing message to the computer 20 to ask another transmission; when the control device 80 certainly receives the refreshing directive from the computer 20, the computer 20 changes the operating mode of the PS2 port used for keyboard into a data-refreshing transmission mode, such that a refreshing program data is transmitted from the PS2 port used for keyboard into the memory 81 of the peripheral community apparatus 10′ for two computers output/input. In the process of data transmission, the control device 80 transmits confirmation signals to the computer 20 while receiving the refreshing program data. If the confirmation signal is not transmitted back to the computer in a certain period of time, the refreshing program data is again transmitted from the computer 20 to the peripheral community apparatus 10′ for two computers output/input. Furthermore, when the peripheral community apparatus 10′ for two computers output/input transmits the confirmation signal, it checks the accumulation sum of the refreshing program data transmitted to confirm that the received data and the transmitted data of the computer 20 are consistent. The consistence of the received data and the transmitted data makes sure the firmware programs being upgraded correctly; when the refreshing procedure and burning work are complete, then the operating mode of the PS2 port used for keyboard is restored. If the process turns out failed, users can transmit the start-refreshing directive and start the whole process over again.

Although a specific embodiment has been illustrated and described, it will be obvious to those skilled in the art that various modifications may be made without departing from what intends to be limited solely by the appended claims. Obviously, many modifications and variations of the present invention are possible in light of the above teachings. It is therefore to be understood that within the scope of the appended claims, the present invention may be practiced otherwise than as specifically described herein.

1. A peripheral community apparatus for computers output/input, wherein said peripheral community apparatus for computers output/input comprising a community port, a first community port, a second community port, a control device and a memory, which the characterized in: said control device is utilized to receive a start-refreshing directive from said computer by the PS2 protocol, and the refreshing program data is burned into said memory to upgrade the firmware; the confirmation signal is transmitted back to said computer by the PS2 protocol so that said computer inspects the transmitted data.

2. The peripheral community apparatus for computers output/input according to claim 1, wherein said refreshing program data is transmitted to said memory through a PS2 port used for keyboard by the PS2 protocol.

3. The peripheral community apparatus for computers output/input according to claim 1, wherein said community port, said first community port and said second community port utilizes the PS2 protocol.

4. The peripheral community apparatus for computers output/input according to claim 1, wherein said memory is located inside said control device.

5. The peripheral community apparatus for computers output/input according to claim 1, wherein said memory is a Flash Memory.
